(19) United States
(12) Patent Application Publication
(10) Pub. No.: US 2002/0095371 A1
(43) Pub. Date: Jul. 18, 2002

(54) Prepaid cash card

(76) Inventor: Joseph E. Odiwo, Deerfield Beach, FL (US)

Correspondence Address: Oltman, Flynn & Kubler, Suite 415, 915 Middle River Drive, Ft. Lauderdale, FL, 33304-3585, US

(21) Appl. No.: 09/760,142

(22) Filed: Jan. 16, 2001

(51) Int. Cl. G06F 17/60

(52) U.S. Cl. 705/39

(57) ABSTRACT

A prepaid cash card with no information about the owner and carrying at least the following information: a unique card identification number in both visible (i.e., humanly readable) and encoded forms, and an encoded unique personal identification number (PIN) for the card owner. A printed receipt issued with the card displays the PIN in visible form. To initiate a transaction the user must give both the card identification number and the PIN.

### BACKGROUND OF THE INVENTION

1. Field of the Invention

This invention relates to a prepaid cash card for making various purchases using the internet.

2. Prior Art

Various credit cards, debit cards, “smart” cards and the like have been proposed heretofore which enable the bearer to make purchases, bank transactions, phone calls, and other business and personal financial transactions.

One problem with such cards is the risk of financial loss and inconvenience to the card owner and/or the financial institution backing the card in the event the card gets lost or is stolen. Typically, such cards have information relating to the card owner that he or she would prefer not to disclose except to the financial institution associated with the card.

Examples of such prior cards are disclosed in the following U.S. Pat. Nos. 5,578,808 Taylor; Menconi 5,847,374; Pitroda 5,884,271 and 5,590,038; Claus et al 5,857,079: Carlisle et al 5,649,118; Gungl et al 5,912,453; Dorf 6,000,608; Brake et al 6,032,136; Thomas 6,064,988; and Hohle et al 6,101,477.

### SUMMARY OF THE INVENTION

This invention relates to a prepaid card a person can use as virtual cash for a variety of purchases, such as buying from a retailer website on the internet, or for a long distance phone call, or for sending a money order.

In accordance with this invention, a novel prepaid cash card is provided which for reasons of security and personal privacy is devoid of information about the card owner and carries at least the following: a unique card identification number in both “visible” (i.e., humanly readable) and encoded forms, and an encoded unique personal identification number (PIN) for the card owner.

Another aspect of the present invention is the provision of a printed receipt, issued to the card owner at the time of purchasing the card, which displays the PIN in visible form for the card owner's use at appropriate times.

This invention also embraces a novel method of doing business on the internet which involves use of both the prepaid cash card and the receipt to initiate an approved purchase of a product or a phone call or a money order transfer of funds covered by the card owner's prepayment.

A principal object of this invention is to provide a novel arrangement enabling the user to use a prepaid card as virtual cash without the inconvenience and disadvantages associated with cash, and with minimal possibility of loss or problems to the user in the event the card gets lost or is stolen.

Further objects and advantages of the invention will be apparent from the following detailed description of a presently preferred embodiment thereof, taken in conjunction with the accompanying drawings.

### BRIEF DESCRIPTION OF THE DRAWINGS

FIG. 1 is a plan view of a card in accordance with this invention, displaying schematically in separate columns the visible information and the encoded information carried by the card; and

FIG. 2 is a similar view of a printed receipt issued to the card purchaser at the time of purchase, listing visible information pertaining to the card.

### DETAILED DESCRIPTION OF THE INVENTION

Before explaining the present invention in detail it is to be understood that the invention is not limited in its application to the particular arrangement shown schematically and described herein since the invention is capable of other embodiments. Also, the terminology used herein is for the purpose of description and not of limitation.

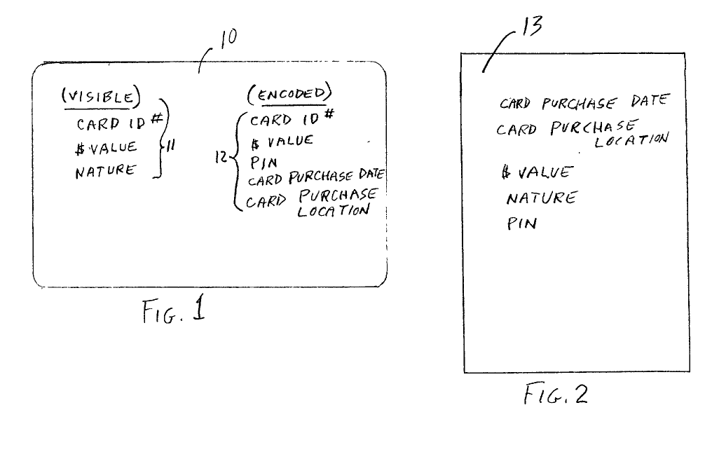

FIG. 1 shows schematically a prepaid cash card 10 in accordance with this invention, with the information that is “visible” (i.e., immediately readable by a human being) listed in one column, shown at 11, and machine-readable encoded information listed in a second column, shown at 12. It is to be understood that the various items of visible information and encoded information may be physically positioned at any convenient locations on the face of the card. They are shown in separate columns in FIG. 1 simply to facilitate an understanding of this invention.

At the time a person purchases the card, the visible information may be covered by a peel-off strip or label which the card owner may remove at any convenient time. The visible information (column 11) includes an identification number unique to the card itself, the dollar value of the card (based on the purchase price), and the nature of the card (e.g., whether or not restricted to adults).

The encoded information (column 12) on the card may be in a conventional bar code or in a magnetic strip of known design, or both bar code and magnetic strip to adapt it for both kinds of code reading equipment. The encoded information on the card 10 includes the card identification number (the same one that is visible on the card), the dollar value of the card at the time of its purchase, the date and location of the card purchase, and a personal identification number (PIN) unique to the person buying the card.

The buyer of this card receives at the time of its purchase a printed receipt, shown schematically at 13 in FIG. 2, on which the following information is displayed in visible (humanly readable) form: the dollar value of the card, its nature (adult or unrestricted), and the card buyer's PIN (which is the same as the PIN encoded on the card itself).

The card 10 contains no information, either visible or encoded, about the person who buys it. It is as anonymous as cash, posing no risk to the rightful owner in case the card is stolen or gets in the hands of someone seeking information about the owner. However, the card is not as fungible as cash because the procedure to make a purchase with the card requires the purchaser to give both the card identification number and the card owner's PIN, which is on the card only in encoded form. As already stated, the buyer of the card will have his or her PIN in visible form on the receipt given at the time of purchasing the card.

At the time a person purchases the card, the card is activated by using conventional card reading equipment at the card vendor'site which reads the encoded information from the card, encrypts it for security reasons in accordance with the usual practice, and transmits it like any other electronic funds transaction (EFT) message to the hub or switch where the card vendor's sales transactions are routed. From here the encoded information read from the card is routed to a server or servers holding the prepaid cash card database of the proprietor organization that sponsors and operates the prepaid card system of the present invention. Here the encrypted information pertaining to the card is decrypted. The just-purchased card is activated immediately by the system proprietor's servers when this encoded information read off the card 10 is received there. Such activation enables the system proprietor's database to process purchases made by the card owner, who from now on can make various purchases using the card as virtual cash. The system proprietor's database will be updated automatically in response to each such purchase so that the dollar amount of virtual cash available to the card owner will be promptly reduced by each purchase he or she makes.

The prepaid cash card of the present invention can be used by the card owner to make purchases on the internet from any retailer website affiliated with the card system proprietor—i.e., one who has agreed to provide its customers with the option of using this card as a way of paying for a purchase and to look to the system proprietor for payment on any such purchase. As soon as the card owner selects this option the retailer prompts this customer for the card identification number and the card owner's PIN. This information from the customer is automatically encrypted and transmitted to the card system proprietor's database, where it is decrypted and used to authorize and guarantee the customer's purchase from the retailer and to make the money payment to the retailer from the card owner's purchase price for the card.

Essentially the same procedure is followed for a phone card transaction when a card owner wants to make a long distance call and pay for it from this card. Of course, the phone company selected by the card owner will have to be one affiliated with the card system proprietor as already explained for a retailer website.

In like manner, the present prepaid cash card may be used for a money order which the card owner wants to pay to his or her chosen payee. The mail order request is processed through the card system proprietor's database, and the card system forwards the money to the designated payee.

The card preferably is made readily destructible since ordinarily it will be machine-scanned only once—at the time of its purchase—for the purpose of activating the card buyer's new account with the card system proprietor. Thereafter, all the card owner needs are the two numbers—the card identification number and the PIN given the card buyer at the time of the card purchase—to make purchases on the internet. The card owner can make note of these two numbers in any way convenient to him or her, such as by writing the card identification number on the receipt that displays the PIN. It is not absolutely necessary, although convenient, for the card owner to hold onto the card after it has been activated.

From the foregoing, it will be apparent that the present card, in conjunction with the card buyer's receipt and the transactional procedure specified, provides the card owner with the flexibility of cash without the attendant disadvantages of having to carry the cash on his or her person and physically hand it over to a payee many miles distant. At the same time, the card owner's risk of using the card or having it stolen is minimized because of the absence of personal information about the card owner on the card itself and the simple yet effective procedure of requiring both the card identification number and the PIN before a transaction is authorized.

I claim:

1. A prepaid payment card displaying a visible card identification number and bearing an encoded card identification number matching said visible card identification number, said card bearing an encoded owner identification number, and said card being free of visible information about the card owner.

2. A prepaid payment card set comprising:
a card displaying a visible card identification number and also bearing an encoded card owner identification number and an encoded card identification number matching said visible card identification number displayed on the card, said card being free of visible information pertaining to the card owner;
and a printed receipt for said card displaying a visible card owner identification number matching said encoded card owner identification number on the card.

3. A business method comprising the steps of:
for payment received, issuing to the payer a card displaying a visible card identification number and bearing an encoded card identification number matching said visible card identification number, said card bearing an encoded owner identification number, and said card being free of visible information about the card owner;
and at the time of issuing said card, issuing to the payer a printed receipt for said card displaying a visible card owner identification number matching said encoded card owner identification number on the card.
